(19) United States
(12) Patent Application Publication
(10) Pub. No.: US 2018/0070732 A1
(43) Pub. Date: Mar. 15, 2018

(54) Micro Lift-OAST Device

(71) Applicants: Ramakrishna Pillay, Etobicoke (CA); Kanakalatha Rudrakoti, Etobicoke (CA)

(72) Inventors: Ramakrishna Pillay, Etobicoke (CA); Kanakalatha Rudrakoti, Etobicoke (CA)

(21) Appl. No.: 15/249,742

(22) Filed: Aug. 29, 2016

Related U.S. Application Data
(60) Provisional application No. 62/212,637, filed on Sep. 1, 2015.

(51) Int. Cl. A47C 12/00; A61G 7/10

(52) U.S. Cl. CPC A47C 12/00; A61G 7/1013; A61G 7/1001

(57) ABSTRACT

In one embodiment, a device includes the upper platform, the scissor assembly coupled to a linear motor and the bottom platform fixed to a part of the existing staircase, occupying slightly more than half the existing standard staircase step length (leaving the other half of the step for normal healthy users; when electrically actuated, the device lifts up/down safely mobility impaired senior in a slow, safe and steady manner. Each individual step is fixed with a micro lift—OSAT device which raises the person to the next level. The person moves horizontally forward one step to the next step, which raises them to next level, so on and so forth.

### PRIORITY

This application claims the benefit, under 35 U.S.C § 119(e), of U.S. Provisional Patent Application No. 62/212,637, filed on 1 Sep. 2015, which is incorporated herein by reference.

### TECHNICAL FIELD

This disclosure relates to assisting mobility impaired/challenged seniors, in climbing up/down the existing staircase steps between different levels at home.

### BACKGROUND

Developed countries as well as developing countries improved health care and advanced medical technologies are contributing to longer average life. Hence there is a boom in the aging population of people different abilities and skills.

A modern trend in managed health care is home care, in which individuals are encouraged to live at home rather than in an institution. Home care generally includes a higher quality of life and can be less expensive and more comforting to the elderly people. Therefore, there is a growing need for devices to enhance the mobility of seniors and other mobility challenged individuals who wish to remain in the comfort of their homes, but have difficulty using stairs.

Traditionally, an elevator or lift in a private residence has been viewed as an expensive luxury exclusively for wheelchair users. Now, people recognize that residential lifts and elevators can benefit many seniors who want to remain in their homes despite loss of mobility, strength or agility. Lifts are typically used to provide access between different floors of a house, or from the ground level outside the house to an inside floor level.

The three main types of available lifts available in the present market:
Vertical platform lift costs anything between $15,000 to 30,000 and requires separate space for mounting the equipment
Inclined platform lift, Escalator requires space to be dug for the installation of equipment and costs between $10000 to $12,000
Stair-chair lift requires extra mounting, costly installation and maintenance costs are high and costs anything between $5000 to 8000.
Micro Step lift—OSAT Device is an ultra-compact stair case lift designed for lifting a person One Step At a Time. The hardware is fixed to a part of the existing staircase floors, occupying slightly more than one half of the existing standard stair step length, leaving the other half for normal use of steps by healthy individuals. It is the most economical lifting device among the existing type of lifts, and does not require expensive installation.

### BRIEF DESCRIPTION OF THE DRAWINGS

FIGS. 1-4 illustrate an example view of a micro lift device.

FIG. 5 illustrates an example electrical schematic of the micro lift device.

FIG. 6 illustrates an example view step-stool variant of micro lift device.

### DESCRIPTION OF THE EXAMPLE EMBODIMENTS

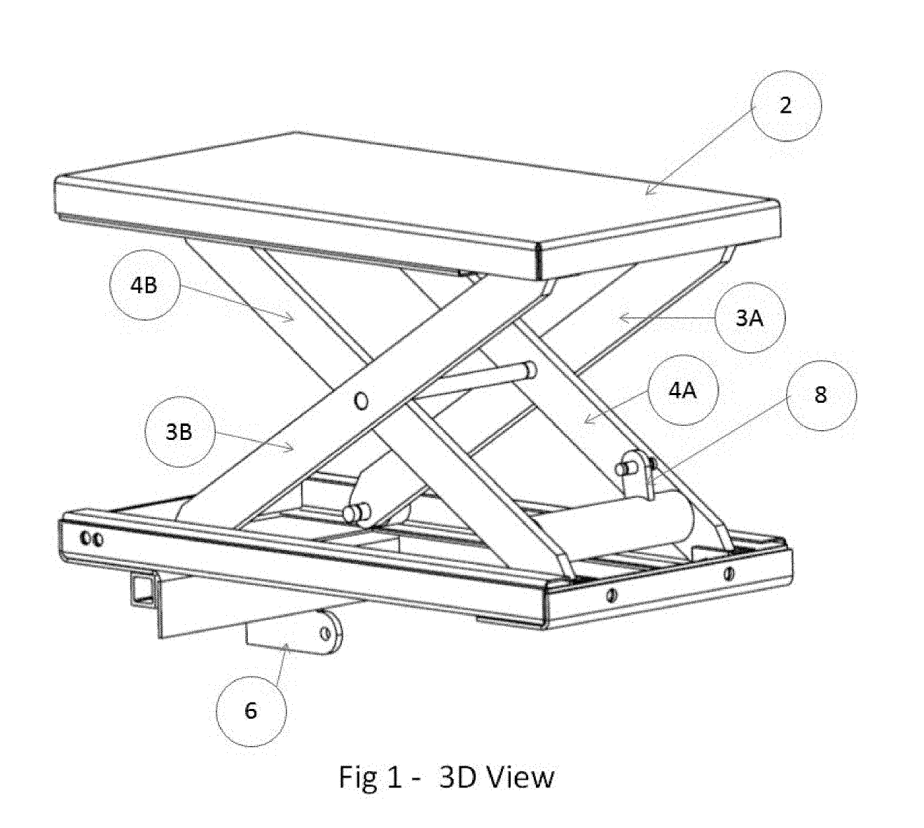

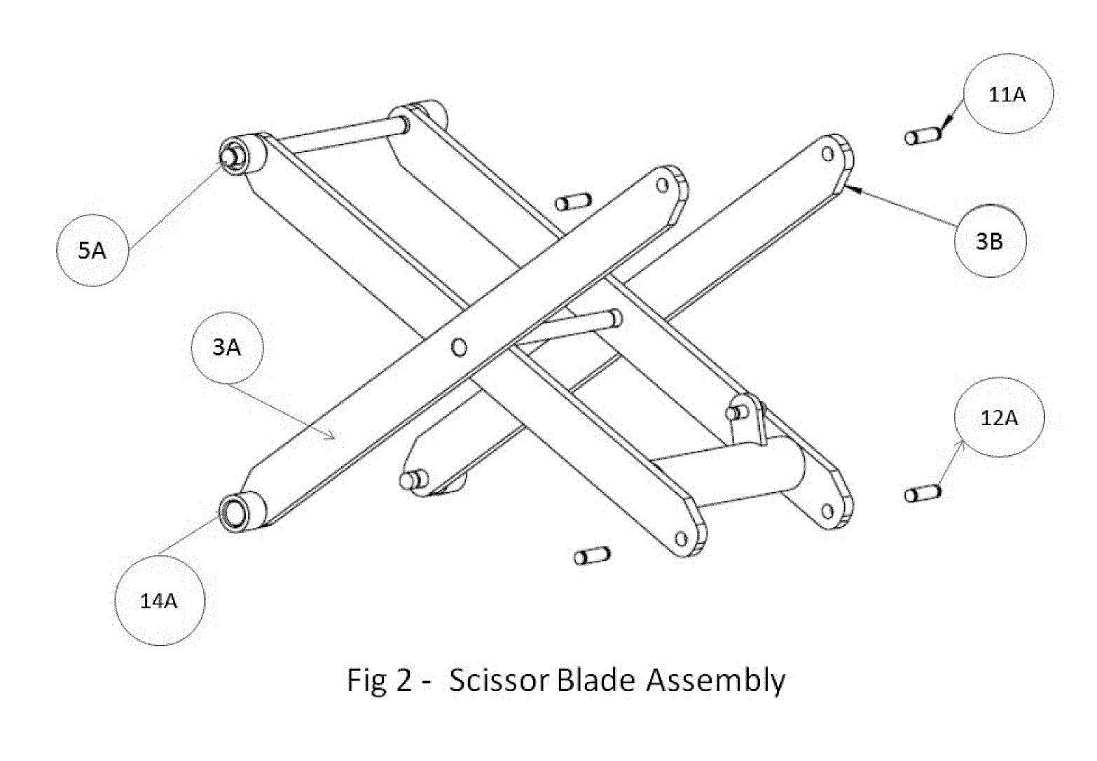

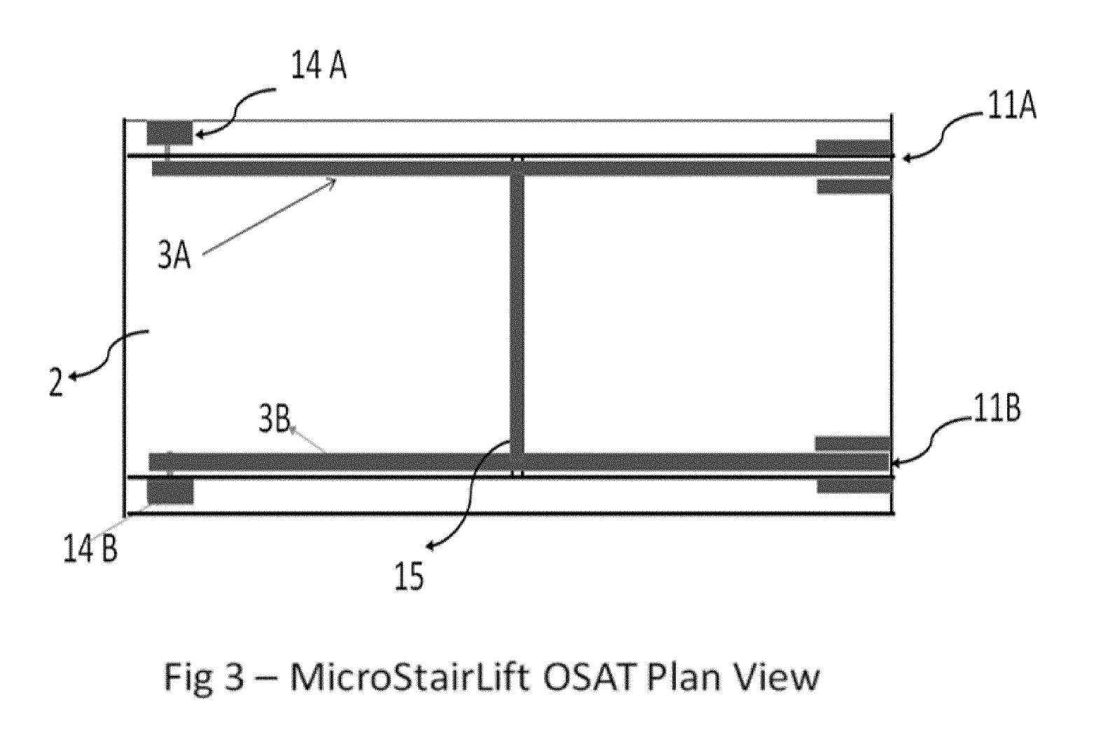

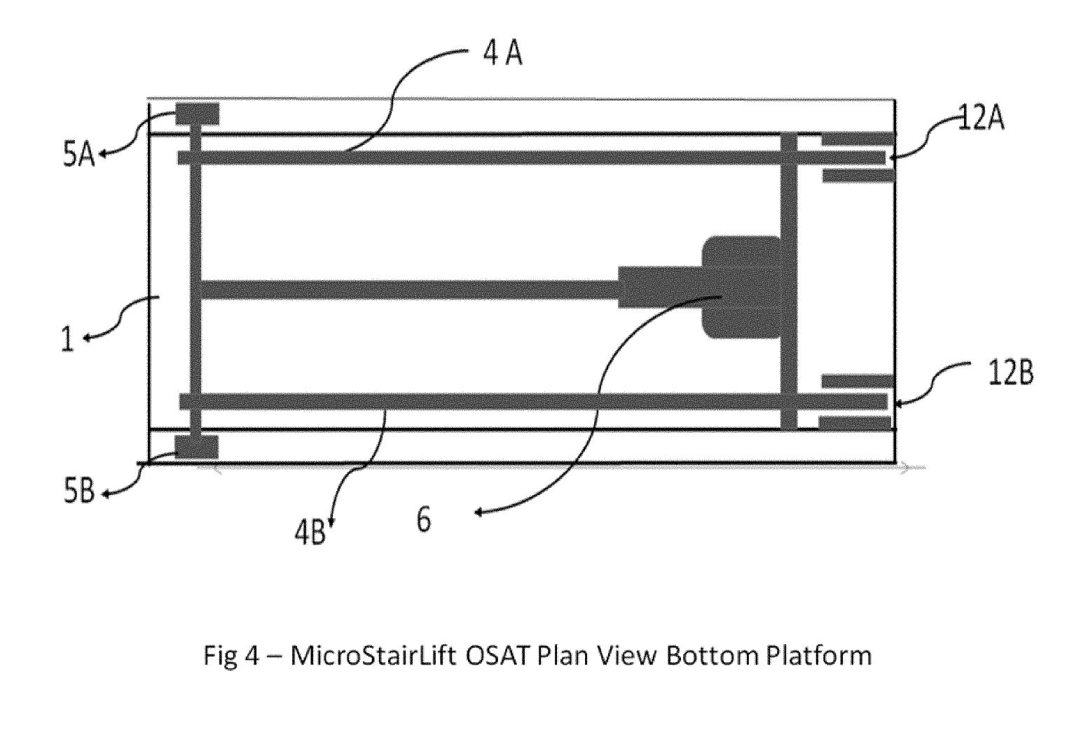

FIGS. 1-4 illustrate example views of a micro lift—OSAT device. In these particular embodiments, the micro lift—OSAT device is used to raise a person to an elevated height of approximately equivalent to one step of a staircase. The electrically operated micro lift—OSAT device 100 is fixed onto the floor of the existing steps of the staircase, occupying slightly less than a half of the length of the standard staircase. The height of transportation is automatically chosen for individual staircase step height ranging from approximately 6 inches to 10 inches. Each individual step is fixed with a micro lift—OSAT device 100 which raises a person to the next step level. The person moves horizontally forward one step to the next micro lift—OSAT device 100, which in turn raises them to the next level, so on and so forth.

In particular embodiments, micro lift—OSAT device 100 includes a number of component elements that include a bottom platform 1 fixed to the stair case step 17, top platform 2, outer scissor blades 3A-3B fixed at one end 11A-11B to the top platform 2, and rollers 14A-14B at the other end moving in the bottom plate channels, inner scissor blades 4A-4B fixed at one end 12A-12B to the bottom platform 1, and rollers 5A-5B at the other end moving in the top platform channels, linear actuator/motor 6 fixed to the bottom platform 1, channel 10, and clamp providing the required mechanical strength, the movable arm of the linear motor 6 coupled to the inner arm 7-8 gives the thrust to lift the top platform 2 and carrying the person by a staircase step height.

Micro lift—OSAT device 100 has set of light-emitting diodes (LEDs) to indicate the health of the system and has a pressure activated switch that is enabled when a person climbs on to micro lift—OSAT device 100, and linear motor 6 operates on standard 110V 60 Hz/230 V 50 Hz electrical outlet. An UPS (not less than 300 W) is not a must, but those interested in enjoying uninterrupted operation (in case of mains failure) may like to opt for the same. The up/down movement is controlled by a hand held remote switch.

Micro lift—OSAT device 100, in which linear motor 6 provides the motion to top platform 2 with respect to bottom platform 1. Linear motor 6 has fixed end coupled to bottom platform 1 and the movable arm mechanically coupled to inner scissor blades 4A-4B. When the person is positioned on top platform 2 and presses the climb switch, linear motor 6 is actuated and moving arm of the linear motor 6 a pushes out/pulls in to climb up or lower down the person standing on top platform 2.

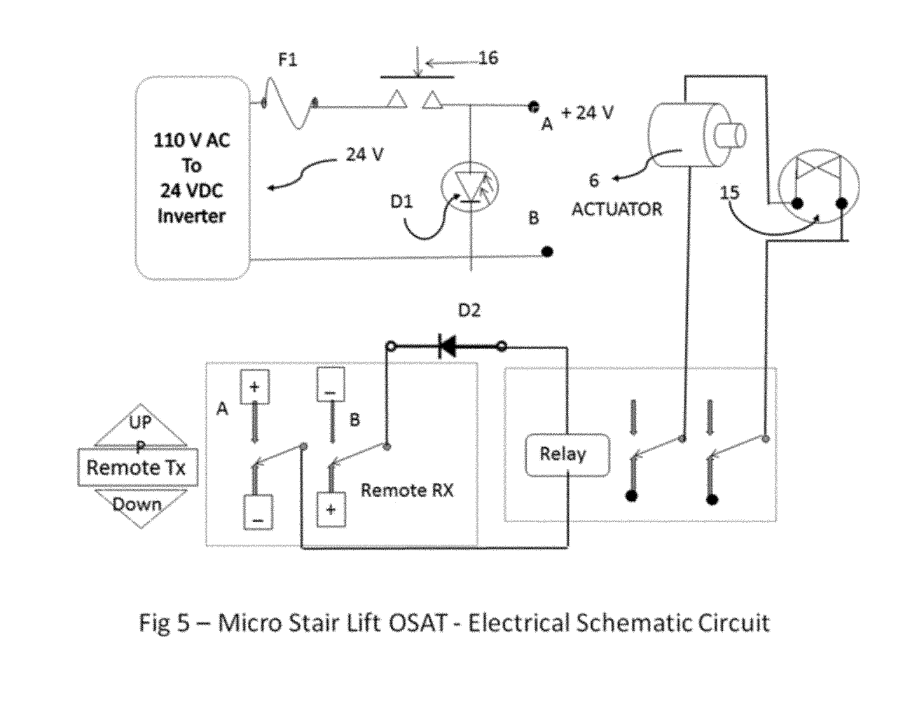

FIG. 5 illustrates an example electrical schematic of the micro lift device. Micro lift—OSAT device 100 includes two limit switches: firstly an infrared sensor limit switch and secondly a standby mechanical operated micro switch to provide extra safety and reliability, that senses the height of the step and automatically cuts off and reverses the supply to linear motor 6 when top platform 2 reaches a pre-determined height (e.g., the height of a step). The micro lift—OSAT device 100 raises the person slowly at the rate of not more than 10 seconds for a step height of 7-9″ in a very slow and steady manner providing stability and comfort to the person standing on the lift platform.

Micro lift—OSAT device 100 may include a voice prompt to operate, automatic safety control, pressure sensor control (unless the person is standing on the lift table at the demarked foot print it would not start). Bottom platform 1 is screwed to the staircase steps floor, hence there is no chance of toppling during the lift up/down phase motion and remains parallel to the ground.

Linear motor 6 may be powered using a 110V, 60 Hz or 230V 50 Hz standard power outlet. An uninterrupted power supply (UPS), is not essential, but for those who desire uninterrupted operation in case of Public mains failure may opt for a UPS (Minimum of 300 Watts). Micro lift—OSAT device 100 has a non-slip surface to prevent a person standing on top platform 2 from sliding off. The handheld remote switch is either mounted on the handrail or operated by remote hand operated switch. The remote control is only for controlling the movement upward or down ward. The automatic limit switches provided take care of the step height, after which even if Up command is given, this will not result in any further upward movement.

Micro lift—OSAT device 100 simplifies moving a person by one staircase step, once raised, the person moves horizontally to another micro lift—OSAT device 100 mounted on the next staircase step (being at the same level). Thus, if there are 5 steps in the split level houses, 5 micro lift devices 100 may be installed on each of the staircase steps. Micro lift—OSAT device 100 mounted on the staircase step raises up or lowers down by one staircase step height to the next staircase step.

Micro lift—OSAT device 100 in which the top platform 2, is suspended on the frame of set of inner scissor blades 11A-11B and outer scissor blades 3A-3B. The system of scissor blades includes outer scissor blades 3A-3B fixed at one end to the top platform 2, and rollers 5A-5B at the moveable end moving in the bottom plate channels. Inner scissor blades 11A-11B fixed at one end to bottom platform 1, and rollers 5A-5B at the other end moving in the top platform channels. The combination of the scissor blades raises or lowers top platform 2 parallel to the step surface, and is adapted to support a mobility impaired senior standing on top platform 2, to be lifted and transported up/down by one stair case step height, when electrically operated, through a vertical motion in a slow, steady and safe motion with no tilt to sides.

Micro lift—OSAT device 100 includes a linear actuator 6 electrically operated, provides the thrust/pull motion to top platform 2 with respect to the lower platform 1. Linear actuator 6 has fixed end coupled to bottom platform 1 and the movable arm 7 mechanically coupled to the inner scissor blades 11A-11B. When the person standing on top platform 2 and presses the climb switch, linear actuator 6 is actuated and moving arm of the linear actuator 6 a pushes out/pulls in to climb up or lower down the individual standing on top platform 2. Micro lift—OSAT device 100 includes a staircase step height sensor that senses the height of the step and automatically cuts off and reverses the supply to linear actuator 6 when top platform 2 reaches the required height, so that the microstep can only be lowered.

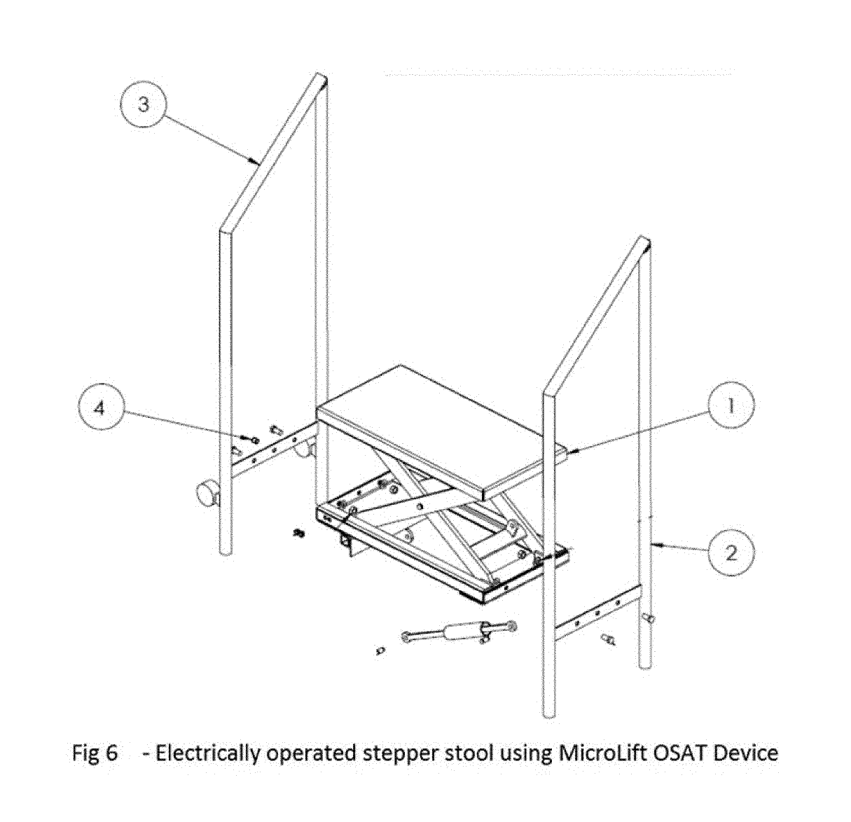

FIG. 6 illustrates an example variant of stepper-stool using the Micro lift—OSAT device 100, the foregoing is considered not only limited to the illustrated embodiment of micro staircase lift device, but also extends to similar lift devices to lift a person for example a house wife, not necessarily mobility impaired persons but normal adults who would like to enjoy the Micro lift—OSAT device 100 power lift capability to raise a standing person from the ground level to the cupboard level and to enable access to reach cupboards in the kitchen, e.g., heights of 6 inches to 16 inches. In this case the Micro lift—OSAT device 100, bottom plate is bolted to the stepper stool handles with the feet resting on the ground. Micro lift—OSAT device 100 includes a linear actuator 6 electrically operated, provides the thrust/pull motion to top platform 2 with respect to the lower platform 1, which has been bolted(6) to the stepper frame left (6.3) and Right(6.2) both the frames resting on the ground. Linear actuator 6 has fixed end coupled to bottom platform 1 and the movable arm 7 mechanically coupled to the inner scissor blades 11A-11B. When the person standing on top platform 2 and presses the climb switch, linear actuator 6 is actuated and moving arm of the linear actuator 6 a pushes out/pulls in to climb up or lower down the individual standing on top platform 2. The height to which the stepper stool is raised is controlled by the use of hand held remote control. After finishing the task of accessing the cupboard, the individual then by the operation of the remote switch down control lowers him/herself back to the ground level.

### SPECIFICATIONS

The specifications of the electrically operated micro lift—OSAT device are:
Drive Linear actuator type
Operation Standard AC power outlet 110V60 Hz/230 V 50 Hz
Self-Installable Yes (Cutting a slot on the wooden staircase step floors, and Mounting of 4 bolts bolted to the stair case floor step)
Standard Capacity 250 lb
Material Steel Alloy
Unit footprint, in use 20″×10″
Elevated step height 6″-10″
Rate of step climb up/down 10 seconds
Safety features Up/down movement control by the use of hand held Remote, voice prompt, built in infrared height sensor and safety micro switch to automatically sense the height of the next level reached and limit the upward movement.

What is claimed is:

1. An apparatus comprising: a top platform suspended on a frame comprising a plurality of inner and outer scissor blades; and the plurality of outer scissor blades fixed to the top platform, wherein the inner scissor blades are fixed at one end to the bottom platform, the scissor blades raises or lowers the top platform by one stair case step height absolutely parallel to the ground.

2. The apparatus of claim 1, further comprising a plurality of rollers moving in a channel of the top platform.

3. The apparatus of claim 1, wherein the lower platform is mounted on a horizontal surface and in this case the staircase floor steps.

4. The apparatus of claim 1, wherein the linear actuator 6 electrically operated, provides the required upward thrust/pull motion to the upper platform with respect to the lower base, and raises the mobility impaired person.
This linear actuator/motor has fixed end coupled to the lower platform and the movable arm 7 mechanically coupled to the inner scissor blades. When mobility impaired senior positions on the upper platform presses the climb up switch, the linear motor is actuated and moving arm of the linear actuator pushes out, to climb up, the individual standing on the upper platform. While the mobility impaired senior is coming down the steps, he positions himself on the upper platform presses the climb-down switch, the linear motor is actuated and moving arm of the linear actuator pulls in to lower down the individual standing on the upper platform
The electrically operated micro staircase lift device in which claim 5, in which a staircase step height sensor senses the height of the step and when the upper platform reaches the required height, automatically cuts off and reverses the supply to the motor, so that platform can be brought down and cannot be taken further up.
The electrically operated micro staircase lift device in which claim 6, the foregoing is considered not only limited to the illustrated embodiment of micro staircase lift device, but also extends to similar lift devices (like stepper stool using micro lift device 100 to lift impaired seniors and or healthy individuals who would like to enjoy the capability of powered stepper stools to raise him/herself to the cupboard levels to enable access to reach cupboards in the kitchen, and after completing the task lower him/herself back to the original ground level.
